(19) United States
(12) Patent Application Publication
(10) Pub. No.: US 2018/0057674 A1
(43) Pub. Date: Mar. 1, 2018

(54) Dynamically Vulcanized Alloys

(71) Applicant: ExxonMobil Chemical Company - Law Technology, Baytown, TX (US)

(72) Inventor: Maria D. Ellul, Silver Lake, OH (US)

(21) Appl. No.: 15/565,916

(22) PCT Filed: Dec. 14, 2015
(86) PCT No.: PCT/US2015/065452

§ 371 Date: Oct. 12, 2017

Related U.S. Application Data
(60) Provisional application No. 62/168,348, filed on May 29, 2015.

(51) Int. Cl. C08L 23/22; C08J 5/18

(52) U.S. Cl. CPC C08L 23/22; C08J 5/18; C08L 2205/025; C08L 2205/03; B60C 1/0008; C08J 2323/22; C08J 2477/02; C08J 2423/22; C08L 2203/16; C08L 2205/22

(57) ABSTRACT

This invention relates to the preparation of a dynamically vulcanized alloy comprising at least one elastomer, at least one thermoplastic resin, graphene, and an ethylene copolymer resin.

### CROSS-REFERENCE TO RELATED APPLICATIONS

This application claims the benefit of priority from U.S. Provisional Application No. 62/168,348 filed May 29, 2015, which is herein incorporated by reference.

### FIELD OF THE INVENTION

The present invention relates generally to dynamically vulcanized alloys of elastomer and thermoplastic resins. More specifically, the present invention relates to dynamically vulcanized alloys containing graphene.

### BACKGROUND OF THE INVENTION

Various types of thermoplastic elastomer compositions containing elastomers, both cured and uncured, and thermoplastic resins are known in the industry. A cured thermoplastic elastomer composition is known as either thermoplastic plastic vulcanizates (TPVs) or as dynamically vulcanized alloys (DVAs). The elastomer in TPVs is dispersed in the thermoplastic resin, providing flexibility and elasticity to the material due to the elastomer and reprocessability due to the thermoplastic resin. These materials are known to be useful in a variety of applications including automotive parts, such as bumpers, knobs, and trim, electrical and applications, such as cable jacketing and connectors, and industrial applications, such as piping, o-rings, sleeves, extruded spiral hoses, and weather stripping. For all of these known applications, the TPVs or DVAs are extruded, cast, blown, or molded to form the final products.

Formation of the DVA may be achieved by a multi-step masterbatch process, a one-pass method, or a combination of the masterbatch and one-pass as further discussed. In the multi-step masterbatch process, the compound is produced by (i) preparing a rubber master batch by mixing, at temperatures below the cross-linking temperature, the elastomer and curative until a uniform mix state is obtained (this is often referred to as pre-conditioning) and (ii) premixing a resin master batch comprising a thermoplastic resin and plasticizers. If desired, conventional fillers and other processing aids may also be added to the rubber master batch. After the masterbatches have been prepared, mixing under shear and vulcanization conditions, along with other composition components, is performed to obtain the DVA. In the one-pass method, the elastomer and at least a portion of thermoplastic resin is added to the mixer to begin viscosity compatibilization and then other system components such as thermoplastic plasticizers and curatives are added into the melt mixture and vulcanization occurs during the last portion of mixing. In a combination system, either the elastomer or thermoplastic resin may be separately mixed with other components before then introducing the preblended component into the final mixer with the remaining DVA components.

DVAs compounded for low permeability (or stated alternatively: high impermeability) applications comprise low-permeability thermoplastic resin, such as polyamide or a blend of polyamides, in which there is dispersed a low-permeability rubber. Such low permeability rubbers include butyl rubber, halobutyl rubbers, or brominated isobutylene para-methylstyrene copolymers. The rubber is cured under conditions of dynamic vulcanization (curing the rubber during melt mixing as opposed to static curing that typically occurs in a rubber mold) and is intimately and uniformly dispersed as a particulate phase within a continuous phase of the thermoplastic resin. In an embodiment, a co-continuous morphology may also be formed. For low permeability applications, it is desired to achieve a composition having sub-micron size dispersed rubber particles. This dispersed cross-linked particle assists the material in having elastic properties.

The elastic nature is desirable for applications requiring flexibility, strength, and elongation. Such properties are also desirable in tire materials. Thus, in recent years, the use of DVAs as tire inner liner layers has been explored. The thermoplastic resin provides a very low permeability to the inner liner layer while the elastomer provides flexibility and durability to the inner liner layer. Accordingly, the inner liner layer formed from DVA can be formed as a very thin layer. Conventional inner liner layers, comprised of only a base elastomer(s), typically have a thickness or gauge in the range of 1.0 to 3.0 mm while inner liner layers formed from DVA have typically a thickness range of 0.08 mm to 0.25 mm.

U.S. Patent Ser. No. 62/058,983, filed on Oct. 2, 2014, discloses a nanocomposite composition having an elastomer, a thermoplastic resin, a nanofiller, and an ethylene copolymer resin. U.S. Patent Application No. 2013/0295367 discloses a composite film or layer with a polymer matrix and graphene. U.S. Patent Application No. 2014/0225026 discloses a method of producing polyamide composites containing graphene. However, past work of in using DVA for tire innerliners has highlighted the need for continued improvement in impermeability of the DVAs.

### SUMMARY OF THE INVENTION

The present invention is directed to a DVA/TPV composition comprising a thermoplastic resin and an elastomer. Preferably the elastomer is a low-permeability rubber.

The present invention is directed to a dynamically vulcanized alloy, the alloy comprising at least one elastomer comprising C₄ to C₇ isomonoolefin derived units; at least one thermoplastic resin having a melting temperature in the range of 170° C. to 260° C.; a graphene; and 2 to 10 phr of an ethylene copolymer resin, wherein the elastomer is present as a dispersed phase of small particles in a continuous phase of the thermoplastic resin.

These and other features, aspects, and advantages of the present invention will become better understood with regard to the following description and appended claims.

### BRIEF DESCRIPTION OF THE FIGURES

FIG. 1 shows the air permeability of various TPVs and TPVs with graphene.

FIG. 2 shows the air permeability of various TPVs and TPVs with EVOH and/or graphene.

### DETAILED DESCRIPTION OF THE INVENTION

Various specific embodiments, versions, and examples are described herein, including exemplary embodiments and definitions that are adopted for purposes of understanding the claimed invention. While the following detailed description gives specific preferred embodiments, those skilled in the art will appreciate that these embodiments are exemplary only, and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

Polymer may be used to refer to homopolymers, copolymers, interpolymers, terpolymers, etc. Likewise, a copolymer may refer to a polymer comprising at least two monomers, optionally with other monomers. When a polymer is referred to as comprising a monomer, the monomer is present in the polymer in the polymerized form of the monomer or in the polymerized form of a derivative from the monomer (i.e., a monomeric unit). However, for ease of reference the phrase comprising the (respective) monomer or the like is used as shorthand.

Elastomer refers to any polymer or composition of polymers consistent with the ASTM D1566 definition: “a material that is capable of recovering from large deformations, and can be, or already is, modified to a state in which it is essentially insoluble, if vulcanized, (but can swell) in a solvent.” In the present invention, elastomers may be referred to as polymers, elastomeric polymers, or rubbers; the term elastomer may be used herein interchangeably with the term rubber or polymer.

The term “phr” is parts by weight per hundred parts of rubber or “parts”, and is a measure common in the art wherein components of a composition are measured relative to a total of all of the elastomer components. The total phr or parts for all rubber components, whether one, two, three, or more different rubber components is present in a given recipe is normally defined as parts per hundred parts of rubber or phr. All other non-rubber components are ratioed against the 100 parts of rubber and are expressed in phr. This way one can easily compare, for example, the levels of curatives or filler loadings, etc., between different compositions based on the same relative proportion of rubber without the need to recalculate percentages for every component after adjusting levels of only one, or more, component(s).

The terms “vulcanized” or “cured” refers to the chemical reaction that forms chemical bonds or cross-links between the polymer chains of an elastomer.

The term “dynamic vulcanization” is used herein to connote a vulcanization process in which a vulcanizable elastomer, present with a thermoplastic resin, is vulcanized under conditions of high shear. As a result of the shear mixing, the vulcanizable elastomer is simultaneously crosslinked and dispersed as fine particles of a “micro gel” within the thermoplastic resin, creating a dynamically vulcanized alloy (“DVA”). The unique characteristic of the DVA is that, notwithstanding the fact that the elastomer component may be fully or partially cured, the DVA can be processed and reprocessed by conventional rubber processing techniques such as extrusion, injection molding, compression molding, etc. Scrap or flashing can be salvaged and reprocessed.

The terms “downstream” and “upstream” when discussing a process or an extruder are given conventional terms in the art. When referencing something as ‘downstream’ in the process or extruder, it means a point in time or location in the process or extruder that is after the referenced point. When referencing something as ‘upstream’ in the process or extruder, it means a point in time or location in the process or extruder that is before the referenced point. For example, if B is introduced downstream of A, then B is introduced into the process or extruder after A and conversely if B is introduced upstream of A, then it is introduced before A.

The DVA has a desired morphology wherein the elastomer is uniformly dispersed as fine particles within the thermoplastic resin. The thermoplastic resin component forms the continuous phase and the elastomer is the dispersed phase even where the rubber to thermoplastic resin ratio is 1.0 or more. The dispersed particle size of the elastomer and the structure of the resin phase are controlled to improve the durability of the DVA, in particular durability at low temperatures.

### Elastomers

The elastomeric component of the DVA may be selected from an assortment of thermosetting, elastomeric materials. For uses where impermeability of the final article to be produced is desired, the use of at least one low-permeability elastomer is desired.

Useful for this invention are elastomers derived from a mixture of monomers, the mixture having at least the following monomers: a C₄ to C₇ isoolefin monomer and a polymerizable monomer. In such mixtures, the isoolefin is present in a range from 70 to 99.5 wt % of the total monomers in any embodiment, or 85 to 99.5 wt % in any embodiment. The polymerizable monomer is present in amounts in the range of from 30 to about 0.5 wt % in any embodiment, or from 15 to 0.5 wt % in any embodiment, or from 8 to 0.5 wt % in any embodiment. The elastomer will contain monomer derived unit amounts having the same weight percentages.

The isoolefin is a C₄ to C₇ compound, non-limiting examples of which are compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The polymerizable monomer may be a C4 to C14 multiolefin such as isoprene, butadiene, 2,3-dimethyl-1,3-butadiene, myrcene, 6,6-dimethyl-fulvene, hexadiene, cyclopentadiene, and piperylene. Other polymerizable monomers such as styrene, alkylstyrene, e.g. p-methylstyrene, and dichlorostyrene are also suitable for preparing a useful elastomer.

Preferred elastomers useful in the practice of this invention include isobutylene-based copolymers. An isobutylene based elastomer or a polymer refers to an elastomer or a polymer comprising at least 70 mol % repeat units from isobutylene and at least one other polymerizable unit. The isobutylene-based copolymer may or may not be halogenated. In an embodiment, ionomer versions of these polyisobutylene polymers may also be used as the elastomeric component of the invention.

In any embodiment of the invention, the elastomer may be a butyl-type rubber or branched butyl-type rubber, especially halogenated versions of these elastomers. Useful elastomers are unsaturated butyl rubbers such as copolymers of olefins or isoolefins and multiolefins. Non-limiting examples of unsaturated elastomers useful in the method and composition of the present invention are poly(isobutylene-co-isoprene), polyisoprene, polybutadiene, polyisobutylene, poly(styrene-co-butadiene), natural rubber, star-branched butyl rubber, and mixtures thereof. Useful elastomers in the present invention can be made by any suitable means known in the art, and the invention is not herein limited by the method of producing the elastomer. Butyl rubber is obtained by reacting isobutylene with 0.5 to 8 wt % isoprene, or reacting isobutylene with 0.5 wt % to 5.0 wt % isoprene—the remaining weight percent of the polymer being derived from isobutylene; the butyl rubber contains monomer derived unit amounts having the same weight percentages.

Elastomeric compositions of the present invention may also comprise at least one random copolymer comprising a C₄ to C₇ isoolefin and an alkylstyrene comonomer. The isoolefin may be selected from any of the above listed C₄ to C₇ isoolefin monomers, and is preferably an isomonoolefin, and in any embodiment may be isobutylene. The alkylstyrene may be para-methylstyrene, containing at least 80%, more alternatively at least 90% by weight of the para-isomer. The random copolymer may optionally include functionalized interpolymers. The functionalized interpolymers have at least one or more of the alkyl substituents groups present in the styrene monomer units; the substituent group may be a benzylic halogen or some other functional group. In any embodiment, the polymer may be a random elastomeric copolymer of a C₄ to C₇ α-olefin and an alkylstyrene comonomer. The alkylstyrene comonomer may be para-methylstyrene containing at least 80%, alternatively at least 90% by weight, of the para-isomer. The random comonomer may optionally include functionalized interpolymers wherein at least one or more of the alkyl substituents groups present in the styrene monomer units contain a halogen or some other functional group; up to 60 mol % of the para-substituted styrene present in the random polymer structure may be the functionalized. Alternatively, in any embodiment, from 0.1 to 5 mol % or 0.2 to 3 mol % of the para-substituted styrene present may be the functionalized.

The functional group may be halogen or some other functional group which may be incorporated by nucleophilic substitution of any benzylic halogen with other groups such as carboxylic acids; carboxy salts; carboxy esters, amides and imides; hydroxy; alkoxide; phenoxide; thiolate; thioether; xanthate; cyanide; cyanate; amino and mixtures thereof. In any embodiment, the elastomer comprises random polymers of isobutylene and 0.5 to 20 mol % para-methylstyrene wherein up to 60 mol % of the methyl substituent groups present on the benzyl ring is functionalized with a halogen such a bromine or chlorine, an acid, or an ester.

In any embodiment, the functionality on the elastomer is selected such that it can react or form polar bonds with functional groups present in the thermoplastic resin, for example, acid, amino or hydroxyl functional groups, when the DVA components are mixed at reactive temperatures.

Brominated poly(isobutylene-co-p-methylstyrene) “BIMSM” polymers useful in the present invention generally contain from 0.1 to 5 mol % of bromomethylstyrene groups relative to the total amount of monomer derived units in the copolymer. In any embodiment of the invention using BIMSM, the amount of bromomethyl groups is from 0.5 to 3.0 mol %, or from 0.3 to 2.8 mol %, or from 0.4 to 2.5 mol %, or from 0.5 to 2.0 mol %, wherein a desirable range for the present invention may be any combination of any upper limit with any lower limit. Also in accordance with the invention, the BIMSM polymer has either 1.0 to 2.0 mol % bromomethyl groups, or 1.0 to 1.5 mol % of bromomethyl groups. Expressed another way, exemplary BIMSM polymers useful in the present invention contain from 0.2 to 10 wt % of bromine, based on the weight of the polymer, or from 0.4 to 6 wt % bromine, or from 0.6 to 5.6 wt %. Useful BIMSM polymers may be substantially free of ring halogen or halogen in the polymer backbone chain. In any embodiment, the random polymer is a polymer of C₄ to C₇ isoolefin derived units (or isomonoolefin), para-methylstyrene derived units and para-(halomethylstyrene) derived units, wherein the para-(halomethylstyrene) units are present in the polymer from 0.5 to 2.0 mol % based on the total number of para-methylstyrene, and wherein the para-methylstyrene derived units are present from 5 to 15 wt %, or 7 to 12 wt %, based on the total weight of the polymer. In any embodiment, the para-(halomethylstyrene) is para-(bromomethylstyrene).

Other suitable low-permeability elastomers are isobutylene containing elastomers such as isobutylene-isoprene-alkylstyrene terpolymers or halogenated isobutylene-isoprene-alkylstyrene terpolymers wherein for each of these terpolymers, the isobutylene derived component in the terpolymer is 70 to 99 wt % of the monomer units in the polymer, the isoprene derived component is 29 to 0.5 wt % of the monomer units in the polymer, and the alkylstyrene derived component is 29 to 0.5 wt % of the monomer units in the polymer.

Suitable C₄ to C₇ isoolefin derived elastomers (including the brominated isobutylene-paramethylstyrene copolymers) having a number average molecular weight Mn of at least about 25,000, preferably at least about 50,000, preferably at least about 75,000, preferably at least about 100,000, preferably at least about 150,000. The polymers may also have a ratio of weight average molecular weight (Mw) to number average molecular weight (Mn), i.e., Mw/Mn of less than about 6, preferably less than about 4, more preferably less than about 2.5, most preferably less than about 2.0. In another embodiment, suitable halogenated isobutylene elastomer components include copolymers (such as brominated isobutylene-paramethylstyrene copolymers) having a Mooney viscosity, ML (1+4) at 125° C. (as measured by ASTM D 1646-99) of 30 or more, or more preferably 40 or more.

Preferred elastomers include copolymers of isobutylene and para-alkylstyrene, which may or may not be halogenated. Preferably the copolymer of isobutylene and para-alkylstyrene is halogenated. Such elastomers are described in EP 0 344 021. The copolymers preferably have a substantially homogeneous compositional distribution. Preferred alkyl groups for the para-alkylstyrene moiety include alkyl groups having from 1 to 5 carbon atoms, primary haloalkyl, secondary haloalkyl having from 1 to 5 carbon atoms and mixtures thereof. A preferred copolymer comprises isobutylene and para-methylstyrene. In any embodiment, brominated copolymers of isobutylene and para-methylstyrene include those having 5 to 12 weight % para-methylstyrene, 0.3 to 1.8 mol % brominated para-methylstyrene, and a Mooney viscosity of 30 to 65, ML(1+4) at 125° C. (as measured by ASTM D 1646-99). In any embodiment, the brominated copolymers of isobutylene and para-methylstyrene include those having 7 to 12 weight % para-methylstyrene, 0.75 to 1.5 mol % brominated para-methylstyrene, and a Mooney viscosity of 30 to 45 (1+4) at 125° C. (as measured by ASTM D 1646-99).

### Thermoplastic Resin

For purposes of the present invention, a thermoplastic (alternatively referred to as thermoplastic resin) is a thermoplastic polymer, copolymer, or mixture thereof having a melting temperature of about 170° C. to about 260° C., preferably less than 260° C., and most preferably less than about 240° C. In a preferred embodiment, the thermoplastic resin should have a molecular weight in the range of 13,000 to 50,000 and/or a Young's modulus of more than 200 MPa at 23° C. By conventional definition, a thermoplastic is a synthetic resin that softens when heat is applied and regains its original properties upon cooling.

Such thermoplastic resins may be used singly or in combination and generally contain nitrogen, oxygen, halogen, sulfur or other groups capable of interacting with an aromatic functional groups such as halogen or acidic groups. Suitable thermoplastic resins include polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK), ethylene acetate copolymer resins (EVA) and mixtures thereof.

Suitable polyamides (nylons) comprise crystalline or resinous, high molecular weight solid polymers including homopolymers, copolymers, and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines Both fiber-forming and molding grade nylons are suitable. Examples of polyamides include polycaprolactam (nylon-6), polylauryllactam (nylon-12), polyhexamethyleneadipamide (nylon-6,6) polyhexamethyleneazelamide (nylon-6,9), polyhexamethylenesebacamide (nylon-6,10), poly(hexamethylene dodecanediamide (nylon-6,12), polyhexamethyleneisophthalamide (nylon-6, IP) and the condensation product of 11-amino-undecanoic acid (nylon-11). Commercially available polyamides may be advantageously used in the practice of this invention, with linear crystalline polyamides having a softening point or melting point between 170 and 260° C. being preferred.

Suitable polyesters which may be employed include the polymer reaction products of one or a mixture of aliphatic or aromatic polycarboxylic acids esters of anhydrides and one or a mixture of diols. Examples of satisfactory polyesters include poly (trans-1,4-cyclohexylene C2-6 alkane dicarboxylates such as poly(trans-1,4-cyclohexylene succinate) and poly (trans-1,4-cyclohexylene adipate); poly (cis or trans-1,4-cyclohexanedimethylene) alkanedicarboxylates such as poly(cis-1,4-cyclohexanedimethylene) oxlate and poly-(cis-1,4-cyclohexanedimethylene) succinate, poly (C2-4 alkylene terephthalates) such as polyethyleneterephthalate and polytetramethylene-terephthalate, poly (C2-4 alkylene isophthalates such as polyethyleneisophthalate and polytetramethylene-isophthalate and like materials. Preferred polyesters are derived from aromatic dicarboxylic acids such as naphthalenic or phthalic acids and C2 to C4 diols, such as polyethylene terephthalate and polybutylene terephthalate. Preferred polyesters will have a melting point in the range of 160° C. to 260° C.

Poly(phenylene ether) (PPE) resins which may be used in accordance with this invention are well known, commercially available materials produced by the oxidative coupling polymerization of alkyl substituted phenols. They are generally linear, amorphous polymers having a glass transition temperature in the range of 190° C. to 235° C.

In the dynamically vulcanized alloy, the thermoplastic resin is present in an amount ranging from about 10 to 98 wt % based on the alloy blend, and from about 20 to 95 wt % in another embodiment. In yet another embodiment, the thermoplastic resin is present in an amount ranging from 35 to 90 wt %. The amount of elastomer in the DVA is in an amount ranging from about 2 to 90 wt % based on the alloy blend, and from about 5 to 80 wt % in another embodiment. In any embodiment of the invention, the elastomer is present in an amount ranging from 10 to 65 wt %. In the invention, the thermoplastic resin is present in the alloy, relative to the amount of elastomer, in an amount in the range of 40 to 90 phr.

### Ethylene Vinyl Alcohol Copolymer (EVOH)

In accordance with the invention, the DVA incorporates a low level of an ethylene copolymer resin to impart improved gas barrier properties in the DVA. Examples of such ethylene copolymer resins include ethylene vinyl acetates, ethylene vinyl alcohols, as well as copolymers of ethylene with vinyl acetate or alkyl acrylates for example methyl acrylate and ethyl acrylate can be employed. In preferred embodiments, the ethylene copolymer resin is an ethylene vinyl alcohol (EVOH).

The EVOH in an embodiment has a polymerized ethylene component proportion of from 20 mol % to not more than 50 mol % and a degree of hydrolysis of 90% or more. In different embodiments, the EVOH has an ethylene content from 30 mol % to 50 mol %, an ethylene content from 30 mol % to 40 mol %, an ethylene content from 30 mol % to 34 mol %, an ethylene content from 34 mol % to 36 mol %, an ethylene content from 36 mol % to 40 mol %, an ethylene content from 40 mol % to 46 mol %, an ethylene content from 46 mol % to 50 mol %, or a mixture thereof, and the like.

In general, higher ethylene contents provide more flexibility, better processability and better compatibility with rubber components, whereas lower ethylene contents and/or a high degree of hydrolysis or saponification are beneficial to improved air barrier properties. In an embodiment, the EVOH is semicrystalline; a higher degree of crystallinity of the EVOH generally improves the air barrier property, i.e., reduces the air transmission rate. In one embodiment, the EVOH is subjected to a heat treatment in the TPE or DVA to increase crystallinity and improve air barrier characteristic. In one embodiment, the EVOH polymer by itself has an air transmission rate at 65% relative humidity and 20° C. by test method ISO 14663-2 annex C of less than 5 cc.20 μm/m².day.atm, preferably less than 3 cc.20 μm/m².day.atm, more preferably less than 2 cc.20 μm/m².day.atm.

The EVOH can be produced, for example, by saponifying an ethylene-vinyl acetate copolymer (EVA) obtained by, for example, a radical polymerization of ethylene and vinyl acetate. In an embodiment, a product commercially available, for example, from EVAL Company of America, may be used alone or in any combinations, such as EVAL E105A (ethylene content 44 mol %), EVAL H171B (ethylene component ratio of 38 mol %), or EVAL L171B (ethylene component ratio of 26 mol %), for example.

The ethylene copolymer resin is present in an amount effective to improve the air barrier properties of the DVA. In any embodiment, the ethylene copolymer resin is present in an amount ranging from greater than about 2 phr, or 5 phr, or 7 phr to less than about 10 phr, preferably in the range of about 2 to about 10 phr.

In any embodiment, the amount of ethylene copolymer resin, such as the above discussed EVOH, is present in an amount less than the primary thermoplastic resin that forms the continuous matrix in the DVA. The ratio of the ethylene copolymer resin to the primary thermoplastic resin, expressed in terms of phr of the primary elastomer, has a range of greater than about 0.0625 to less than about 0.375, or 0.5, or 0.75.

### Graphene

To form the desired elastomeric nanocomposite, graphene is incorporated into the elastomeric polymer. Graphene is an organic material comprised of layers of carbon atoms arranged in a honeycomb lattice. The use of graphene as an additive to address barrier properties in compositions is generally described in B. M. Yoo, et al., Graphene and Graphene Oxide and Their Uses in Barrier Polymers, Journal of Applied Polymer Science (2013), which is incorporated herein by reference. The graphene may be physically modified to a single sheet structure, or small pieces. In an embodiment, the graphene consists of nanoplatelets having a thickness in the range of about 50 to about 100 nm. Graphene is known to be a strong material and has a Young's modulus of about 1 TPa. In an embodiment, the graphene has a carbon content in the amount of about 99 wt % and an oxygen content in the amount of about 1.4%

The graphene used in the present invention may be prepared by methods known in the industry, including but not limited to chemical vapor deposition on metal substrates, epitaxial grown on SiC or metal substrates, from mechanical cleavage of graphite, and/or via the thermal and chemical reduction of graphene oxide.

In an embodiment of the invention, the graphene is believed to be segregated in the interphase between the elastomer and the thermoplastic resin to make the DVA composition with improved air barrier properties.

The amount of graphene incorporated in the DVA generally will range from 1 phr or 2 phr or 3 phr or 4 phr or 5 phr to 6 or 7 or 8 or 10 or 15 phr.

### Secondary Elastomer

In some embodiments, the DVA may further comprise a secondary elastomer. The secondary elastomer may be any elastomer, but preferably the secondary elastomer is a non-isobutylene-containing elastomer. An example of a preferred secondary elastomer is a maleic anhydride-modified copolymer. Preferably, the secondary elastomer is a copolymer comprising maleic anhydride and ester functionalities such as maleic anhydride-modified ethylene-ethyl acrylate.

The amount of the secondary elastomer in the DVA may be in the range of from about 2 wt % to about 45 wt %. If the DVA comprises at least one elastomer and a secondary elastomer, the total amount of both the elastomer and secondary elastomer is preferably in the range of from about 2 wt % to about 90 wt %.

This secondary elastomer may be cured along with the primary isoolefin based elastomer or it may be selected to remain uncured and act as a compatibilizer as discussed below.

### Other DVA Components

Other materials may be blended into the DVA to assist with preparation of the DVA or to provide desired physical properties to the DVA. Such additional materials include, but are not limited to, curatives, stabilizers, compatibilizers, reactive plasticizers, non-reactive plasticizers, extenders and polyamide oligomers or low molecular weight polyamide as described in U.S. Pat. No. 8,021,730 B2.

Curing of the primary elastomer is generally accomplished by the incorporation of the curing agents and optionally accelerators, with the overall mixture of any such components referred to as the cure system or cure package. Suitable curing components include sulfur, metal oxides, organometallic compounds, radical initiators. Common curatives include ZnO, CaO, MgO, Al2O3, CrO3, FeO, Fe2O3, and NiO. These metal oxides can be used alone or in conjunction with metal stearate complexes (e.g., the stearate salts of Zn, Ca, Mg, and Al), or with stearic acid or other organic acids and either a sulfur compound or an alkyl or aryl peroxide compound or diazo free radical initiators. If peroxides are used, peroxide co-agent commonly used in the art may be employed. The use of peroxide curative may be avoided if the thermoplastic resin is one such that the presence of peroxide would cause the thermoplastic resin to cross-link.

As noted, accelerants (also known as accelerators) may be added with the curative to form a cure package. Suitable curative accelerators include amines, guanidines, thioureas, thiazoles, thiurams, sulfenamides, sulfenimides, thiocarbamates, xanthates, and the like. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR90), N-tertiarybutyl-2-benzothiazole sulfenamide (TBBS), N-(1,3-dimethylbutyl)-N′-phenyl-p-phenylenediamine (6PPD), and N-oxydiethylene thiocarbamyl-N-oxydiethylene sulfonamide (OTOS), zinc 2-ethyl hexanoate (ZEH), N,N′-diethyl thiourea.

In any embodiment of the invention, at least one curing agent is typically present at about 0.1 to about 15 phr; alternatively at about 1.0 to about 10 phr, or at about 1.0 to 6.0 phr, or at about 1.0 to 4.0 phr, or at about 1.0 to 3.0 phr, or at about 1.0 to 2.5 phr, or at about 2.0 to 5.0 phr. If only a single curing agent is used, it is preferably a metal oxide such as zinc oxide.

Minimizing the viscosity differential between the elastomer and the thermoplastic resin components during mixing and/or processing enhances uniform mixing and fine blend morphology that significantly enhance good blend mechanical as well as desired permeability properties. However, as a consequence of the flow activation and shear thinning characteristic inherent in elastomeric polymers, reduced viscosity values of the elastomeric polymers at the elevated temperatures and shear rates encountered during mixing are much more pronounced than the reductions in viscosity of the thermoplastic component with which the elastomer is blended. It is desired to reduce this viscosity difference between the materials to achieve a DVA with acceptable elastomeric dispersion sizes.

Components previously used to compatibilize the viscosity between the elastomer and thermoplastic components include low molecular weight polyamides, maleic anhydride grafted polymers having a molecular weight on the order of 10,000 or greater, methacrylate copolymers, tertiary amines and secondary diamines One common group of compatibilizers are maleic anhydride-grafted ethylene-ethyl acrylate copolymers (a solid rubbery material available from Mitsui-DuPont as AR-201 having a melt flow rate of 7 g/10 min measured per JIS K6710), as well as butylbenzylsulfonamide and polyisobutylene succinic anhydride; the use of such additives are further discussed in pending U.S. spplication Ser. No. 12/548,797, filed Aug. 29, 2009. These compounds may act to increase the ‘effective’ amount of thermoplastic material in the elastomeric/thermoplastic compound. The amount of additive is selected to achieve the desired viscosity comparison without negatively affecting the characteristics of the DVA. If too much additive is present, impermeability may be decreased and the excess may have to be removed during post-processing. If not enough compatibilizer is present, the elastomer may not invert phases to become the dispersed phase in the thermoplastic resin matrix.

Both reactive and non-reactive plasticizers can function as compatibilizers due to the nature of a plasticizer. Plasticizers for thermoplastics are generally defined as a compound added to polymeric materials to improve flexibility, extensibility, and processability. Known and conventional thermoplastic plasticizers are supplied in the form of low to high viscosity liquid and may be functionalized. Many different plasticizers are known in the thermoplastic resin art as plasticizers have different compatibilities with each type of thermoplastic resin and have different effects on the properties of the thermoplastic resin. Known thermoplastic plasticizers include different types of esters, hydrocarbons (aliphatic, naphthenic, and aromatic), polyesters, and polycondensates; see Handbook of Thermoplastic Elastomers, Jiri George Drobny, p. 23 (William Andrew Publishing, 2007). For polyamides, known non-reactive plasticizers include hydrocarbons functionalized by tertiary amines, secondary diamines, or sulfonamides. One particularly well known compound is butylbenzylsulfonamide (BBSA).

Both maleic and succinic anhydrides functionalized oligomers are also useful as reactive plasticizers or reactive viscosity modifiers. The anhydride functionalized oligomer (AFO) may be prepared by thermal or chloro methods known in the art of reacting an alkyl, aryl, or olefin oligomer with anhydride, preferably maleic anhydride. The oligomer, including copolymers of lower olefins, before being reacted with the anhydride, has a molecular weight in the range of about 500 to 5000, or 500 to 2500, or 750 to 2500, or 500 to 1500. The oligomer may also have a molecular weight in the ranges of 1000 to 5000, 800 to 2500, or 750 to 1250. Specific examples of succinic anhydrides include poly-isobutylene succinic anhydride, poly-butene succinic anhydride, n-octenyl succinic anhydride, n-hexenyl succinic anhydride, and dodocenyl succinic anhydride. The most preferred anhydride functionalized oligomers are those derived from polyisobutene and are commonly known as polyisobutylene succinic anhydride or polyisobutene succinic anhydride (PIBSA). The PIBSA may be made by cationic polymerization of isobutene with boron trifluoride as catalyst. In the course of the polymerization, high concentrations of α-olefins are formed during the transfer reaction and as a result the polymerization product has a high proportion of terminal double bonds (α-olefin). They are normally clear to amber viscous liquids and are specially optimized during the post polymerization maleation reaction to have a low bismaleation.

The anhydride level of the AFO may vary and a preferred range is about 1% to about 30 wt % with a preferred range of 5 to 25 wt % and a more preferred range of 7 to 17 wt % and a most preferred range of 9 to 15 wt %.

### DVA Preparation

In an embodiment, prior to preparation of the DVA, the graphene or graphene oxide may first be incorporated into the primary elastomer. This can be done by any previously known methods such as melt blending, solution blending, or emulsion blending. Suitable dispersants known in the art of mixing graphene may be added to facilitate the dispersion of graphene.

Melt blending of the graphene and elastomer is carried out by combining the polymer components and the graphene in any suitable mixing device such as a Banbury™ mixer, Brabender™ mixer or preferably a mixer/extruder and mixing at temperatures in the range of 120° C. up to 300° C. under conditions of shear sufficient to allow the graphene to become uniformly dispersed within the polymer to form a nanocomposite.

For solution blending, the graphene is blended into the elastomer by contacting Solution A comprising a hydrocarbon solvent, optionally a dispersing agent, and at least one graphene slurried therein with Solution B comprising a solvent and at least one elastomer (Solution B is commonly referred to as a cement due to dissolving of the elastomer in the solvent), and removing the solvents from the contact product of Solution A and Solution B to form a nanocomposite. Suitable solvents include hydrocarbons such as alkanes, including C₄ to C₂₂ linear, cyclic, branched alkanes, alkenes, aromatics, and mixtures thereof. During solvent mixing, the solution created by the combination of Solution A and Solution B contains 40 to 99 wt % of solvent, with the remainder being the dissolved elastomer and the slurried graphene.

For emulsion blending, an aqueous slurry of graphene is mixed with a polymer dissolved in a solvent (i.e. a polymer cement). The mixing should be sufficiently vigorous to form emulsions or micro-emulsions and permit exfoliation of the layered filler. In some embodiments, the emulsions can be formed as an aqueous solution or suspension in an organic solution. The solvent and water are removed to recover the nanocomposite.

To obtain the desired emulsion, a surfactant is typically used. The surfactant concentration is sufficient to allow the formation of a relatively stable emulsion. Preferably, the amount of surfactant employed is at least 0.001 wt % of the total emulsion. The selection of the surfactant in the present invention must be such that it does not (a) interfere with the later grafting of the primary elastomer and the thermoplastic resin during formation of the DVA, or (b) undesirably alter the relative viscosities of the nanocomposite and thermoplastic resin during formation of the DVA.

The difference between solution blending and emulsion blending is the inclusion of water in the emulsion blending and, conversely, the absence of water in the solution blending. When using either of these solvent based methods of incorporation of the graphene into the elastomer, the resulting nanocomposite should be dried to remove as much solvent as possible so that residual solvent does not affect the relative viscosities of the elastomer and thermoplastic resin during preparation of the DVA.

After the elastomeric nanocomposite has been prepared, the DVA is prepared. For thin films, of the type to be used for preparing tire inner liners, the morphology of the DVA is critical in obtaining the desired properties. Uniform distribution of submicron or nanometer sized elastomer particles in a continuous thermoplastic matrix is important to achieve optimum properties. Sub-inclusions of the thermoplastic inside the rubber particles may also be present; but for any sub-inclusions in the elastomer, the thermoplastic resin will preferably not be discontinuous in the DVA. The morphology of the DVA is dependent upon the mixing conditions, including temperature, order of introducing ingredients, residence time, as well as shear rates; it has been determined that using any randomly selected or on-hand variety of mixers and extruders may not provide the necessary DVA morphology.

In one embodiment, the DVA is prepared by jointly feeding into an initial feed throat of an extruder the elastomeric nanocomposite and all or part of the primary thermoplastic resin to begin mixing and shearing of the elastomeric nanocomposite and thermoplastic resin. As the material travels through the extruder, the ethylene copolymer resin may be added if present at a feed port distanced from the initial feed throat. These components are mixed under conditions such that the two resins are melted and the elastomeric nanocomposite becomes pliable and the elastomer component of the elastomeric nanocomposite and the primary thermoplastic resin begin to graft to each other; however, the conditions are insufficient to initiate curing or vulcanization of the elastomer. If needed, any remaining primary thermoplastic resin is added after grafting has initiated. In a preferred embodiment, only after grafting of the primary thermoplastic resin and elastomer has progressed, are curatives or a cure package fed into the extruder at a downstream location. Mixing of the extruder contents continues until the elastomeric nanocomposite is fully dispersed as discrete particles in a continuous domain of the thermoplastic resin. More details of this mixing method, as well as shear rates, mixing conditions, and extruder port locations, are disclosed in Assignees PCT Patent Application PCT/US2013/065001, filed Oct. 15, 2013, having a priority claim to U.S. Provisional Application 61/740,114, filed Dec. 20, 2012.

### EXAMPLES

The inventive DVAs will now be further described with reference to the following non-limiting examples. When possible, standard ASTM tests were used to determine the DVA's physical properties.

Air permeability, also referred to herein as “permeability”, “Mocon”, or “Mocon permeability” was measured using a MOCON OxTran Model 2/61 operating under the principle of dynamic measurement of air transport through a thin film. The units of measure are cc-mm/m2-day-mmHg Generally, the method is as follows: flat film or rubber samples are dried for 2 hours at 150° C. and then clamped into diffusion cells which are purged of residual oxygen using an oxygen free carrier gas. The carrier gas is routed to a sensor until a stable zero value is established. Pure oxygen or air is then introduced into the outside of the chamber of the diffusion cells at a temperature of 60° C. The air diffusing through the film to the inside chamber is conveyed to a sensor which measures the air diffusion rate. Permeability is measured in cc-mm/m2-day-mmHg at 60° C. A listing of various components used in the DVA samples is provided in Table 1.

TABLE 1

| Material | Brief Description | Commercial Source |
|---|---|---|
| BIMSM 1 | 10 wt % PMS, 0.85 mol % BrPMS, Mooney viscosity | ExxonMobil Chemical |
| | of 31 ± 5 MU (1 + 8, 125° C.) | |
| BIMSM 2 | 5 wt % PMS, 0.75 mol % BrPMS, Mooney viscosity | ExxonMobil Chemical |
| | of 45 ± 5 MU (1 + 8, 125° C.) | |
| BIMSM 3 | 7.5 wt % PMS, 1.2 mol % BrPMS, Mooney viscosity | ExxonMobil Chemical |
| | of 45 ± 5 MU (1 + 8, 125° C.) | |
| ZnO | Zinc Oxide | Kadox 911 Zinc Corp. |
| Talc | Hydrous magnesium silicate Mg₃Si₄O₁₀(OH)₂ | SG 2000; Nippon |
| Polyamide 1 | PA6/66 copolymer | C3301; BASF |
| Polyamide 2 | PA6 homopolymer | Ultramid B27; BASF |
| EVOH | Ethylene Vinyl Alcohol Copolymer 48 mol % Ethylene | Soarnol H4815B |
| Graphene | N008-100-P-10, Nano Graphene Platelets | Angstron Materials, Inc. |
| | Thickness~50-100 nm | Dayton, OH |
| | X-Y dimensions, 10 um max. | |
| | Carbon content~99%; O2 content 1.4% | |
| Stabilizer | 0.22 phr | Irganox 1098; Ciba |
| Package | 0.09 phr | Tinuvin 622LD; Ciba |
| | 0.02 Copper Iodide | Sigma-Aldrich |
| PIBSA | Polyisobutylene succinic anhydride, MW before | PIBSA 950 from Texas |
| | anhydride reaction = 950-1000, viscosity at 100° C. = | Petrochemicals LP |
| | 459 cSt, saponification # = 100 mg KOH/gm | Or |
| | | Dovermulse H1000 from |
| | | Dover Chemical Corp. |

DVA samples A, B, and C were prepared to show the characteristics of the DVAs when the DVA excludes both an ethylene copolymer resin and graphene. The compositions of samples are provided in Table 2 below, with the amount of each component expressed in terms of parts per hundred rubber. In these samples, in terms of wt % of the DVA, the BIMSM elastomer is present at 52.7 wt % and the primary thermoplastic resin, the polyamide copolymer, is present in an amount of 36.9 wt %.

TABLE 2

| | A | B | C |
|---|---|---|---|
| BIMSM 1 | 100 | — | — |
| BIMSM 2 | — | 100 | — |
| BIMSM 3 | — | — | 100 |
| Polyamide | 59 | 59 | 59 |
| Polyamide 2 | 16 | 16 | 16 |
| Zinc oxide | 2 | 2 | 2 |
| Talc | 2 | 2 | 2 |
| PIBSA | 10 | 10 | 10 |
| Stabilizer Package | 0.48 | 0.48 | 0.48 |

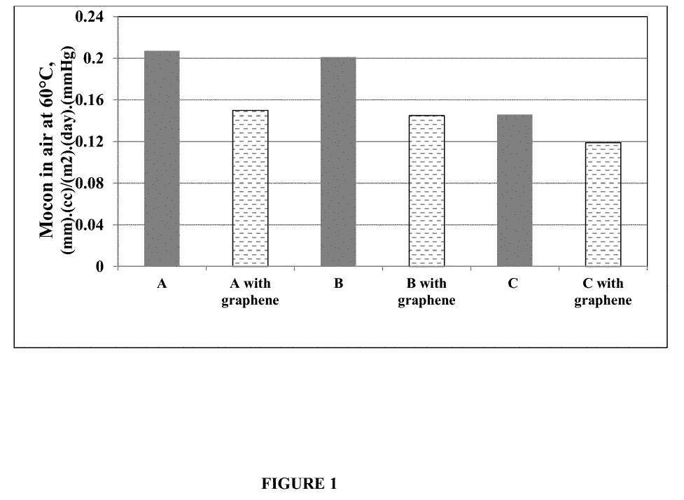

The oxygen permeability of DVAs A-C was tested and is reported in FIG. 1. To test the effect of adding graphene to the DVA compositions, 10 phr of graphene was added to each of the DVAs of Table 2 such that the sum total of BIMSM and graphene is 100 phr. As all three compositions indicate, the addition of graphene favorably reduces the Mocon air permeability, with one sample showing an approximately 40% improvement in the Mocon air permeability value. FIG. 1 indicates that the introduction of graphene in the elastomer results in improved barrier properties of the resulting composition.

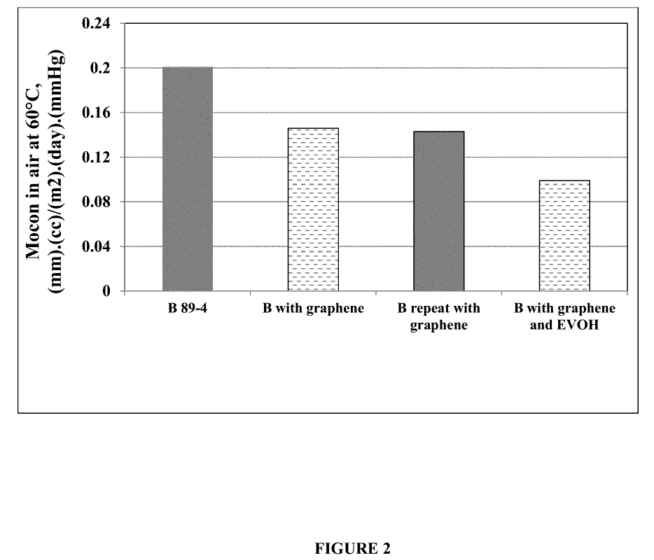

FIG. 2 shows the air permeability of DVAs B with graphene and/or EVOH. The addition of 10 phr of graphene and/or 7.9 phr of EVOH favorably reduces the Mocon air permeability, in comparison to DVAs without EVOH and/or graphene. DVA B indicates that the addition of graphene in combination with EVOH unexpectedly reduces the Mocon permeability of the composition, in comparison to DVA B with only graphene. FIG. 2 indicates that compositions with improved air impermeability can be achieved with the addition of a combination of EVOH and graphene.

While the above specification and examples are specific to low permeability elastomers as the principal/primary elastomer, as the described process is directed to a solution for creating DVAs of a reactive mixture wherein interfacial grafting occurs, the process may be used with other types of elastomers and thermoplastics (and secondary materials) wherein the mixture is a reactive mixture (exclusive of any cross-linking reaction due to added curatives).

### INDUSTRIAL APPLICABILITY

The inventive compositions can be used to make any number of articles. In one embodiment, the article is selected from tire curing bladders, tire innerliners, tire innertubes, and air sleeves. In another embodiment, the article is a hose or a hose component in multilayer hoses, such as those that contain polyamide as one of the component layers. Other useful goods that can be made using compositions of the invention include air spring bladders, seals, molded goods, cable housing, and other articles disclosed in THE VANDERBILT RUBBER HANDBOOK, PP. 637-772 (Ohm, ed., R.T. Vanderbilt Company, Inc. 1990).

All priority documents, patents, publications, and patent applications, test procedures (such as ASTM methods), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The invention has been described above with reference to numerous embodiments and specific examples. Many variations will suggest themselves to those skilled in this art in light of the above detailed description. All such obvious variations are within the full intended scope of the appended claims.

1. A dynamically vulcanized alloy, the alloy comprising:
a. at least one elastomer comprising C₄ to C₇ isomonoolefin derived units;
b. at least one thermoplastic resin having a melting temperature in the range of 170° C. to 260° C.;
c. a graphene; and
d. 2 to 10 phr of an ethylene copolymer resin,
wherein the elastomer is present as a dispersed phase of small particles in a continuous phase of the thermoplastic resin.

2. The alloy as claimed in claim 1, wherein the ethylene copolymer resin is selected at least one of ethylene vinyl acetate, ethylene vinyl alcohol, copolymers of ethylene with vinyl acetate, copolymers of ethylene with alkyl acrylates, and combinations thereof.

3. The alloy as claimed in claim 1, wherein the graphene is an organic carbon-based filler.

4. The alloy as claimed in claim 1, wherein the graphene is in the range of 4 to 15 phr.

5. The alloy as claimed in claim 1, wherein the ethylene copolymer resin has not more than 50 mol % of ethylene.

6. The alloy as claimed in claim 1, wherein the ethylene copolymer resin is ethylene vinyl alcohol.

7. The alloy as claimed in claim 1, wherein the ratio of the ethylene copolymer resin to the thermoplastic resin, expressed in terms of phr of the elastomer, is in the range of 0.0625 to 0.75.

8. The alloy as claimed in claim 1, wherein the alloy is further comprised of a secondary elastomer.

9. The alloy as claimed in claim 8, wherein the secondary elastomer is maleic anhydride-modified copolymer.

10. The alloy as claimed in claim 1, wherein the alloy is further comprised of at least one compatibilizer or viscosity modifier, namely polisobutylene succinic anhydride.

11. The alloy as claimed in claim 1, wherein the thermoplastic resin is selected from at least one of polyamides, polyimides, polycarbonates, polyesters, polysulfonates, polyactones, polyacetals, acrylonitrile-butadiene-styrene resins, polyphenyleneoxide, polyphenylene sulfide, polystyrene, styrene-acrylonitrile resins, styrene maleic anhydride resins, aromatic polyketones, ethylene acetate copolymer resins, and mixtures thereof.

12. The alloy as claimed in claim 10, wherein the thermoplastic resin is a polyamide selected from the group consisting of nylon-6, nylon-12, nylon-6,6, nylon-6,9, nylon-6,10, nylon-6,12, nylon-6,66 copolymer, nylon-11, and mixtures thereof.

13. The alloy as claimed in claim 1, wherein the elastomer is an isobutylene derived elastomer.

14. The alloy as claimed in claim 1, wherein the elastomer is a copolymer of an isobutylene and an alkylstyrene.

15. The alloy as claimed in claim 1, wherein the elastomer is present in the alloy in an amount in the range of from about 2 to about 90 wt % based on the total alloy blend weight or the thermoplastic resin is present in the alloy in an amount in the range of from 10 to 98 wt % based on the total alloy blend weight.

16. The alloy as claimed in claim 1, wherein the thermoplastic resin is present in the alloy in an amount of 40 to 90 phr.

17. The alloy as claimed in claim 1, wherein the elastomer is an isobutylene-paramethylstyrene copolymer.

18. The alloy as claimed in claim 17, wherein the isobutylene-paramethylstyrene copolymer is brominated.

19. An article made from the dynamically vulcanized alloy as set forth in claim 1, wherein the article is a tire innerliner or a tire bladder or is incorporated as a layer into a tire, a bladder, a hose, a belt, pneumatic spring, or vehicle body mount.

20. A film formed from the dynamically vulcanized alloy as set forth in claim 1.

21. The film as claimed in claim 19, wherein the film has a permeability coefficient of less than or equal to 0.16 cc-mm/m2-day-mmHg.
